(19) United States
(12) Patent Application Publication
(10) Pub. No.: US 2014/0339933 A1
(43) Pub. Date: Nov. 20, 2014

(54) ELECTRIC MACHINE INCLUDING AN ADAPTABLE COOLING SYSTEM

(71) Applicant: REMY TECHNOLOGIES, L.L.C., Pendleton, IN (US)

(72) Inventors: Noman Hossain, Fort Wayne, IN (US); Anthony Trzaska, Carmel, IN (US)

(73) Assignee: REMY TECHNOLOGIES, L.L.C., Pendleton, IN (US)

(21) Appl. No.: 13/894,936

(22) Filed: May 15, 2013

(51) Int. Cl. H02K 9/00

(52) U.S. Cl. CPC H02K 9/005
USPC 310/53

(57) ABSTRACT

An electric machine includes a housing having an outer surface and an inner surface. A stator is fixedly mounted to the inner surface. The stator includes a stator core, and a plurality of windings supported by the stator core. The plurality of windings includes first and second end turn portions. A rotor is rotatably mounted within the housing. An adaptable cooling system is fluidically connected to the housing. The adaptable cooling system includes a first coolant circuit configured to guide coolant in a heat exchange relationship with the stator core, and a second coolant circuit configured to guide coolant in a heat exchange relationship with the at least one end turn portion. At least one flow controller is configured and disposed to selectively adapt coolant delivery through the first and second coolant circuits based on coolant temperature flowing from the stator.

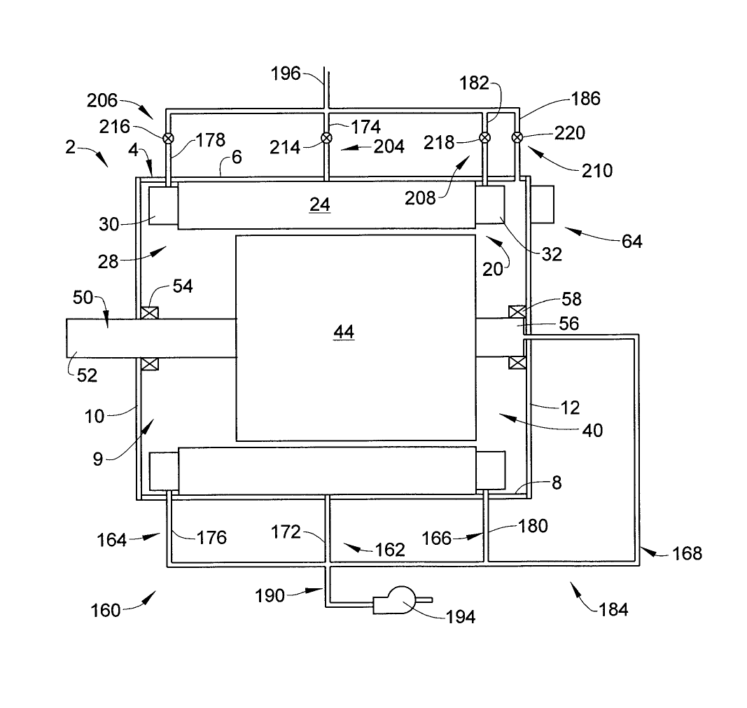

### BACKGROUND OF THE INVENTION

Exemplary embodiments pertain to the art of electrical machines and, more particularly, to an electric machine having an adaptable cooling system.

Many electric machines include cooling systems. The cooling systems take on various forms and are configured to reduce operating temperatures of the electric machine to extend component service life. Electric motors often times will include a cooling system having a rotor or armature driven fan. The fan guides a cooling fluid through the electric motor to dissipate heat. Other cooling systems include passing a fluid through a coolant jacket that surrounds a portion of the electric machine and direct spraying of coolant onto one or more internal components of the electric machine.

### BRIEF DESCRIPTION OF THE INVENTION

Disclosed is an electric machine including a housing having an outer surface and an inner surface. A stator is fixedly mounted to the inner surface. The stator includes a stator core and a plurality of windings supported by the stator core. The plurality of windings includes a first end turn portion and a second end turn portion. A rotor is rotatably mounted in the housing. An adaptable cooling system is fluidically connected to the housing. The adaptable cooling system includes a first coolant circuit configured to guide a coolant in a heat exchange relationship with the stator core, and a second coolant circuit configured to guide a coolant in a heat exchange relationship with at least one of the first and second end turn portions. At least one flow controller is operably connected to the adaptable cooling system. The at least one controller is configured and disposed to selectively adapt coolant delivery through the first and second coolant circuits in response to coolant temperature flowing from one of the stator core, and one of the first and second end turn portions.

Also disclosed is an electric machine including a housing having an outer surface and an inner surface, and a stator fixedly mounted to the inner surface. The stator includes a stator core and a plurality of windings supported by the stator core. The plurality of windings includes a first end turn portion and a second end turn portion. A rotor is rotatably mounted in the housing. An adaptable cooling system is fluidically connected to the housing. The adaptable cooling system includes a first coolant circuit configured to guide a coolant in a heat exchange relationship with the stator core, and a second coolant circuit configured to guide coolant to the rotor. At least one flow controller is configured and disposed to selectively adapt coolant delivery through the first and second coolant circuits in response to the coolant temperature flowing from one of the stator core and the rotor.

Further disclosed is an electric machine including a housing having an outer surface and an inner surface, and a stator fixedly mounted to the inner surface. The stator includes a stator core and a plurality of windings supported by the stator core. The plurality of windings includes a first end turn portion and a second end turn portion. A rotor is rotatably mounted in the housing. An adaptable cooling system is fluidically connected to the housing. The adaptable cooling system includes a first coolant circuit configured to guide a coolant in a heat exchange relationship with the at least one of the first and second end turn portions, and a second coolant circuit configured to guide coolant to the rotor. At least one flow controller is configured and disposed to selectively adapt coolant delivery through the first and second coolant circuits in response to the coolant temperature flowing from one of the first and second end turn portions and the rotor.

### BRIEF DESCRIPTION OF THE DRAWING

The following descriptions should not be considered limiting in any way. With reference to the accompanying drawing, like elements are numbered alike:

The FIGURE depicts an electric machine including an adaptive cooling system in accordance with one aspect of an exemplary embodiment.

### DETAILED DESCRIPTION OF THE INVENTION

A detailed description of one or more embodiments of the disclosed apparatus and method are presented herein by way of exemplification and not limitation with reference to the FIGURE.

An electric machine in accordance with an exemplary embodiment is indicated generally at 2 in the FIGURE. Electric machine 2 is shown in the form of an electric motor having a housing 4 including an outer surface 6 and an inner surface 8 that defines an interior portion 9. Housing 4 also includes a first end wall 10 and an opposing, second end wall 12. At least one of end walls 10 and 12 may be removable to provide access to interior portion 9. Electric machine 2 is also shown to include a stator 20 arranged in interior portion 9. Stator 20 includes a stator core 24 fixedly mounted to interior surface 8. Stator core 24 supports a plurality of stator windings 28 that include a first end turn portion 30 and a second end turn portion 32.

Electric machine 2 is also shown to include a rotor assembly 40 including a rotor 44 supported by a shaft 50. Rotor 44 can take on a variety of forms and many include windings and/or permanent magnets. Shaft 50 includes a first end 52 supported at first end wall 10 through a first bearing 54, and a second end 56 supported at second end wall 12 through a second bearing 58. It should be understood that rotor assembly 40 should not be limited to being supported at both ends of shaft 50. Rotor 44 may also be supported in a cantilevered fashion from one of first and second end walls 10 and 12. Electric machine 2 is also shown to include a terminal block 64 that provides an interface between windings 28 and external electrical sources or loads.

In accordance with an exemplary embodiment electric machine 2 includes an adaptive cooling system 160. Adaptive cooling system 160 includes a first coolant circuit 162, a second coolant circuit 164, a third coolant circuit 166 and a fourth coolant circuit 168. First coolant circuit 162 includes a first inlet portion 172 that passes coolant in a heat exchange relationship with stator core 24 and a first outlet section 174 that guides the coolant from housing 4. Second coolant circuit 164 includes a second inlet portion 176 that passes coolant in a heat exchange relationship with first end turn portion 30 and a second outlet section 178 that guides coolant from housing 4. Third coolant circuit 166 includes a third inlet portion 180 that passes coolant in a heat exchange relationship with second end turn portion 32 and a third outlet section 182 that guides the coolant from housing 4. Fourth coolant circuit 168 includes an fourth inlet portion 184 fluidically connected to rotor 44 and a fourth outlet section 186 that is fluidically connected to housing 4. Adaptive cooling system 160 is also shown to include an inlet 190 fluidically connected to first, second, third and fourth inlet portions 172, 176, 180 and 184. Inlet 190 is also fluidically connected to a coolant pump 194. An outlet 196 is fluidically connected to first, second, third and fourth outlet sections 174, 178, 182 and 186.

In accordance with an aspect of the exemplary embodiment, adaptive cooling system 160 includes a first flow controller 204 arranged in first outlet section 174, a second flow controller 206 arranged in second outlet section portion 178, a third flow controller 208 arranged in third outlet section 182 and a fourth flow controller 210 arranged in fourth outlet section 186. First flow controller 204 is shown in the form of a first thermostatic valve 214, second flow controller 206 is shown in the form of a second thermostatic valve 216, third flow controller 208 is shown in the form of a third thermostatic valve 218 and fourth flow controller 210 is shown in the form of a fourth thermostatic valve 220. First, second, third and fourth flow controllers 204, 206, 208 and 210 control coolant flow based on temperatures of coolant flowing through each thermostatic valve 214, 216, 218 and 220.

First thermostatic valve 214 responds to changes in temperature of coolant flowing through first outlet section 174. Similarly, second thermostatic valve 216 responds to changes in temperature of coolant flowing through second outlet section 178, third thermostatic valve 218 responds to changes in temperature of coolant flowing through third outlet section 182 and fourth thermostatic valve 220 responds to changes in temperature of coolant flowing through fourth outlet section 186.

With this arrangement, a constant flow of coolant is passed through first inlet portion 172, second inlet portion 176, third inlet section 180 and fourth inlet section 184. If a temperature of coolant flowing through one or more of first, second, third and/or fourth outlet sections 174, 178, 182 and 186 increases, a corresponding one of thermostatic valves 214, 216, 218 and 220 opens proportionally allowing for an increase in coolant flow. As the temperature of the coolant flowing through the one or more of first, second, third and/or fourth outlet sections 174, 178, 182 and 186 decreases, the corresponding one of thermostatic valves 214, 216, 218 and 220 closes proportionally to reduce coolant flow. In this manner, coolant flow can be adapted to selectively address temperature conditions at stator core 24, first and second end turn portions 30 and 32, and/or rotor 44

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing including an outer surface and an inner surface;
a stator fixedly mounted to the inner surface, the stator including a stator core and a plurality of windings supported by the stator core, the plurality of windings including a first end turn portion and a second end turn portion;
a rotor rotatably mounted in the housing;
an adaptable cooling system fluidically connected to the housing, the adaptable cooling system including a first coolant circuit configured to guide a coolant in a heat exchange relationship with the stator core, and a second coolant circuit configured to guide a coolant in a heat exchange relationship with at least one of the first and second end turn portions; and
at least one flow controller configured and disposed to selectively adapt coolant delivery through the first and second coolant circuits in response to coolant temperature flowing from one of the stator core, and one of the first and second end turn portions.

2. The electric machine according to claim 1, wherein the first coolant circuit includes an first inlet portion configured to lead coolant to the housing and an first outlet section configured to lead coolant out from the housing, and the second coolant circuit includes an second inlet portion configured to lead coolant to the housing and an second outlet section configured to lead coolant from the housing.

3. The electric machine according to claim 2, wherein the at least one flow controller comprises a thermostatic valve arranged in one of the first and second outlet sections.

4. The electric machine according to claim 3, wherein the at least one thermostatic valve includes a first thermostatic valve arranged in the first outlet section and a second thermostatic valve arranged in the second outlet section.

5. The electric machine according to claim 2, wherein the at least one flow controller includes a first flow controller arranged in the first outlet section and a second flow controller arranged in the second outlet section.

6. The electric machine according to claim 5, further comprising: a third coolant circuit including a third inlet portion configured to lead coolant to the other of the first and second end turn portions and a third outlet section configured to lead coolant from the housing, the third coolant circuit including a third flow controller arranged in the third outlet section.

7. The electric machine according to claim 6, further comprising: a fourth coolant circuit including a fourth inlet portion configured to guide coolant to the rotor and a fourth outlet portion configured to guide coolant from the housing, the fourth coolant circuit including a fourth flow controller arranged in the fourth outlet section.

8. An electric machine comprising:
a housing including an outer surface and an inner surface;
a stator fixedly mounted to the inner surface, the stator including a stator core and a plurality of windings supported by the stator core, the plurality of windings including a first end turn portion and a second end turn portion;
a rotor rotatably mounted in the housing;
an adaptable cooling system fluidically connected to the housing, the adaptable cooling system including a first coolant circuit configured to guide a coolant in a heat exchange relationship with the stator core, and a second coolant circuit configured to guide coolant to the rotor; and
at least one flow controller configured and disposed to selectively adapt coolant delivery through the first and second coolant circuits in response to the coolant temperature flowing from one of the stator core and the rotor.

9. The electric machine according to claim 8, wherein the at least one flow controller comprises at least one thermostatic valve configured to control coolant flow through at least one of the first and second coolant circuits based on coolant temperature.

10. The electric machine according to claim 8, wherein the at least one flow controller comprises a first thermostatic valve configured to control coolant flow through the first coolant circuit and a second thermostatic valve configured to control coolant flow through the second coolant circuit.

11. The electric machine according to claim 8, further comprising a third coolant circuit configured to guide a coolant to one of the first and second end turn portions, the third coolant circuit including a third flow controller.

12. The electric machine according to claim 11, wherein the third flow controller comprises a thermostatic valve configured to control coolant flow through the third coolant circuit based on the coolant temperature.

13. An electric machine comprising:
a housing including an outer surface and an inner surface;
a stator fixedly mounted to the inner surface, the stator including a stator core and a plurality of windings supported by the stator core, the plurality of windings including a first end turn portion and a second end turn portion;
a rotor rotatably mounted in the housing;
an adaptable cooling system fluidically connected to the housing, the adaptable cooling system including a first coolant circuit configured to guide a coolant in a heat exchange relationship with at least one of the first and second end turn portions, and a second coolant circuit configured to guide coolant to the rotor; and
at least one flow controller configured and disposed to selectively adapt coolant delivery through the first and second coolant circuits in response to the coolant temperature flowing from one of the first and second end turn portions and the rotor.

14. The electric machine according to claim 13, wherein the at least one flow controller comprises at least one thermostatic valve configured to control coolant flow through at least one of the first and second coolant circuits based on coolant temperature.

15. The electric machine according to claim 13, wherein the at least one flow controller comprises a first thermostatic valve configured to control coolant flow through the first coolant circuit and a second thermostatic valve configured to control coolant flow through the second coolant circuit.

16. The electric machine according to claim 13, further comprising a third coolant circuit configured to guide a coolant to the stator core, the third coolant circuit including a third flow controller.

17. The electric machine according to claim 16, wherein the third flow controller comprises a thermostatic valve configured to control coolant flow through the third coolant circuit based on the coolant temperature.

18. The electric machine according to claim 13, further comprising: a fourth coolant circuit configured to guide a coolant to the other of the first and second end turn portions, the fourth coolant circuit including a fourth flow controller.

19. The electric machine according to claim 18, wherein the fourth flow controller comprises a thermostatic valve configured to control coolant flow through the fourth coolant circuit based on the coolant temperature.
